(19) United States
(12) Patent Application Publication
(10) Pub. No.: US 2015/0131980 A1
(43) Pub. Date: May 14, 2015

(54) Heating Device

(71) Applicant: SANDEN CORPORATION, Isesaki-shi (JP)

(72) Inventor: Yoshinobu Maemura, Isesaki-shi (JP)

(21) Appl. No.: 14/400,331

(22) PCT Filed: May 8, 2013
(86) PCT No.: PCT/JP2013/062922

§ 371 Date: Nov. 10, 2014

(30) Foreign Application Priority Data
May 10, 2012 (JP) 2012-108325

(51) Int. Cl. F24H 9/20; F24H 1/10; H05B 1/02

(52) U.S. Cl. CPC F24H 9/2028; H05B 1/0202; H05B 1/0236; F24H 1/103; F24H 2250/02
USPC 392/488; 219/510

(57) ABSTRACT

A heating device includes a heater (2) having a heating portion (6) which generates heat by energization; a housing (4) which contains the heating portion and forms a passage (18) for a heating medium between the housing and the heating portion; a temperature detection means (26) for detecting the temperature of the heating medium in the passage; and an energization interrupting means for interrupting the carrying of current to the heater depending on the temperature of the heating medium detected by the temperature detection means. The temperature detection means is pressed into contact with the heating portion.

### TECHNICAL FIELD

The present invention relates to heating devices, and particularly to a heating device including a housing which forms a passage for a heating medium between the housing and a heating portion of a heater.

### BACKGROUND ART

It is known that a heating device of this kind includes a heater having a heating portion which generates heat by energization; a housing which contains the heating portion and forms a passage for a heating medium between the housing and the heating portion; a temperature detection means for detecting the temperature of the heating medium in the passage; and an energization interrupting means for interrupting the carrying of current to the heater depending on the detected temperature of the heating medium.

Patent Document 1 discloses a heating device which is provided with a thermostat or a thermal fuse at the outside of the housing, on a surface shared with the heating face of the heating portion. Thus, the heating device prevents accidental heating of the passage with no heating medium while preventing a malfunction in the thermal fuse.

Patent Document 2 discloses a heating device which is provided with a thermal fuse at the current-carrying terminal. Heat transferred from the heating portion via the current-carrying terminal causes the heating device to interrupt the carrying of current to the heater regardless of the level of the heating medium in the passage so as to prevent accidental heating of an empty passage.

Patent Document 3 discloses a heating device which is provided with a convex on the inside of the housing. The heating device prevents accidental heating of the passage with no heating medium by placing a thermal fuse into contact with the heating portion via the convex of the housing.

Prior Art Document

Patent Document

Patent Document 1: Japanese Patent No. 4561319

Patent Document 2: Japanese Patent No. 4293091

Patent Document 3: Japanese Patent No. 3395571

### SUMMARY OF THE INVENTION

### Problems to be solved by the Invention

Unfortunately, a heating device according to each of the Patent Documents 1 to 3 is unable to stop the heater swiftly due to a deterioration in the responsiveness of the energization interrupting means because the heating device has its temperature detection means placed into contact with a non-heating portion of the heater located outside the housing, and the carrying of current to the heater is interrupted based on heat transferred via the non-heating portion. For that reason, the accuracy of detection of accidental heating of an empty passage can be decreased, leading to an occurrence of smoke or fire. When the heater, the housing and the temperature detection means are each made of different materials, inconsistencies in the coefficients of linear expansion and contraction among these different materials can cause displacements of a point of temperature measurement of the temperature detection means depending on the temperature at which the heating device is used, especially when the temperature detection means is fasten to the housing with screws or the like. This can further deteriorate the responsiveness of the energization interrupting means and consequently decrease the accuracy of detection of accidental heating of an empty passage.

The present invention has been made based on the above-mentioned circumstances, and an object of the present invention is to provide a heating device capable of detecting accidental heating of an empty passage with high accuracy by detecting the temperature of the heating medium, interrupting energization with excellent responsiveness, and securely preventing an occurrence of smoke or fire so as to improve reliability of the heating device.

### Means for Solving the Problems

In order to achieve the above object, a heating device of the present invention includes a heater having a heating portion which generates heat by energization; a housing which contains the heating portion and forms a passage for a heating medium between the housing and the heating portion; a temperature detection means for detecting the temperature of the heating medium in the passage; and an energization interrupting means for interrupting the carrying of current to the heater depending on the temperature of the heating medium detected by the temperature detection means. An elastic member presses the temperature detection means into contact with the heating portion.

Preferably, the elastic member has an elastic force capable of pressing the temperature detection means upon the heating portion against respective forces of the heating portion, the temperature detection means and the housing in linear expansion and linear contraction acting in a direction parallel to the pressing direction of the temperature detection means toward the heating portion.

Preferably, the temperature detection means is connected to the housing via a seal member, and it is preferred that the elastic member has an elastic force capable of pressing the temperature detection means upon the heating portion against the frictional force of the seal member acting in a direction parallel to the pressing direction of the temperature detection means toward the heating portion.

Preferably, the elastic member has an elastic force capable of pressing the temperature detection means upon the heating portion against an internal pressure acting on the passage in a direction parallel to the pressing direction of the temperature detection means toward the heating portion.

Preferably, the housing comes into contact with the elastic member via a heat-insulation member.

Advantageous Effects of the Invention

According to the present invention, a heating device with high reliability can be provided owing to the following reasons. The heating device includes a temperature detection means for detecting the temperature of a heating medium in a passage for the heating medium, and an energization interrupting means for interrupting the carrying of current to a heater depending on the temperature of the heating medium detected by the temperature detection means. The heating device is capable of detecting accidental heating of an empty passage with high accuracy and reliability by detecting the temperature of the heating medium, interrupting energization with excellent responsiveness and securely preventing an occurrence of smoke or fire because the temperature detection means is pressed into contact with a heating portion of the heater.

### BRIEF DESCRIPTION OF THE DRAWINGS

FIG. 1 is a longitudinal sectional view of a heating device in accordance with an embodiment of the present invention.

FIG. 2 is a cross-sectional view illustrating a principal part of the heating device taken from line A-A in FIG. 1.

FIG. 3 is a longitudinal sectional view of a heating device in accordance with a variation of the present invention.

FIG. 4 is a cross-sectional view illustrating a principal part of the heating device taken from line B-B in FIG. 3.

### MODE FOR CARRYING OUT THE INVENTION

A heating device in accordance with an embodiment of the present invention will now be described with reference to the attached drawings.

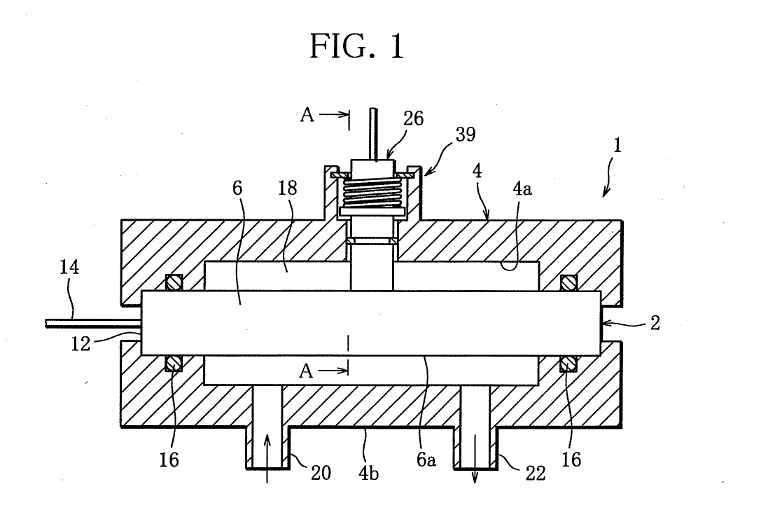

As shown schematically in FIG. 1, a heating device 1 includes a heater 2 and a case (housing) 4 which contains the heater 2.

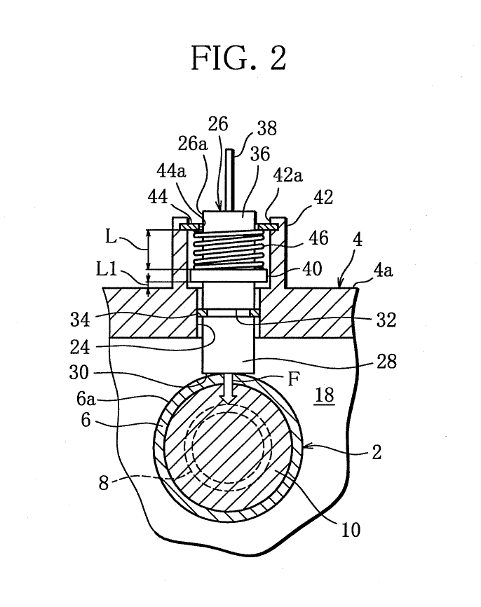

As shown schematically in FIG. 2, the heater 2 is an electrothermal heater which generates heat by energization. The heater 2 is composed of a bottomed cylindrical metal pipe 6 (heating portion) made of, for example, stainless steel. A coiled heating wire 8 such as a nichrome wire is inserted in the metal pipe 6, and a heat-resistant insulating material 10, such as magnesium oxide, having high electrical insulation properties and thermal conductivity is filled into the metal pipe 6 by pressure to seal the heating wire 8.

A terminal 12 molded from silicon, glass and the like by casting is provided at one end opening of the metal pipe 6. A lead wire 14 connected to the heating wire 8 is pulled through the terminal 12. The lead wire 14 and an external power unit (not shown) electrically connected to the lead wire 14 constitute an energization circuit (not shown) for providing the heating wire 8 with electricity. Although only one heater 2 is shown in FIG. 1, two or more heaters 2 may be provided.

The case 4 is composed of one or more cast bodies made of, for example, an aluminum alloy. The case 4 contains the heater 2 by airtightly surrounding vicinities of both ends of the metal pipe 6 through O-rings 16.

Clearance is created between an inner surface 4a of the case 4 and an outer circumference 6a of the metal pipe 6. The clearance serves as a passage 18 into which a heating medium as a LLC (coolant, antifreeze), such as ethylene glycol, flows. An inlet pipe 20 and an outlet pipe 22 for the heating medium are protrusively provided at appropriate positions on an outer surface 4b of the case 4 so that the both pipes communicate with the passage.

The heating device 1 having such a schematic configuration, which is to be mounted, for example, in a hybrid car, an electric vehicle and the like, is used to heat a coolant or the like circulating through a refrigeration circuit in an air conditioning apparatus for a vehicle, serving as an auxiliary heat source for providing heat to make up a shortage in waste heat out of the engine in the case of a hybrid car, or as an alternative heat source for providing heat in place of the engine that does not exist in the case of an electric vehicle.

For example, in the case of a hybrid car, an LLC circulating in a cooling water circuit (not shown) for cooling an engine flows via the inlet pipe 20 into the passage 18, and the heater 2 heats the LLC. Heat from the LLC which has been heated by the engine and the heating device 1 is used to heat a coolant circulating through a refrigeration circuit provided in an air conditioning apparatus for the vehicle. The heated coolant is used to heat and cool the air in the vehicle cabin. The LLC which has been used for heating the coolant is discharged from the passage 18 via the outlet pipe 22 and returned to the cooling water circuit. Then, the LLC is again used to cool the engine.

According to the present embodiment, a through-hole 24 is bored into the case 4 in a direction perpendicular to the longitudinal direction of the heater 2. A temperature sensor 26 (temperature detection means) for detecting the temperature of a LLC which flows through the passage 18 is inserted in the through-hole 24. The temperature sensor 26 is, for example, a roughly cylindrical shaped thermistor covered with a brass material. An end face 30 of a temperature measurement end 28 of the sensor 26 comes into contact with the outer circumference 6a of the metal pipe 6 of the heater 2. This enables the temperature sensor 26 to detect not only the temperature of the LLC but also the surface temperature of the metal pipe 6, i.e. the heating portion of the heater 2.

An annular groove 32 is formed on a side 26a of the temperature sensor 26. An O-ring 34 (seal member) is fitted to the annular groove 32. The temperature sensor 26 is airtightly connected to and secured to the through-hole 24 through the O-ring 34.

The present embodiment further includes a pressing mechanism 39 for pressing the temperature sensor 26 against the metal pipe 6.

Specifically, a circular flange 40 with a diameter larger than that of the through-hole 24 is formed on the side 26a of the temperature sensor 26. The flange 40 is positioned outside the through-hole 24 of the case 4. A circular fixing part 42 for settling the temperature sensor 26 is protrusively provided at the opening edge of the through-hole 24 on the outer surface 4b of the case 4.

A circular snap ring 44 is inserted into an inner surface 42a of the fixing part 42. An outer end 36 of the temperature sensor 26 protrudes through a ring opening 44a of the snap ring 44 in a noncontact manner. The temperature sensor 26 is permitted to move in the hole direction of the through-hole 24.

Further, a spring 46 (elastic member) is locked between the opposing faces of the snap ring 44 and the flange 40. The spring 46 is wound around and attached to the side 26a of the temperature sensor 26 on the outer end 36 side with respect to the flange 40.

The spring 46 is composed of, for example, a steel material for spring having a predetermined elastic modulus G. In FIG. 2, the spring 46 is shortened from its natural length to that of a distance L between the snap ring 44 and the flange 40. A predetermined elastic force F based on the elastic modulus G and the distance L is applied to the flange 40 in the extending direction of the spring 46. In this state, the flange 40 is spaced apart by a distance L1 from the outer surface 4b of the case 4, and the end face of the temperature sensor 26 is pressed against the outer circumference 6a of the metal pipe 6 with the elastic force F in the direction shown by the arrow in FIG. 2.

As described above, the metal pipe 6, the temperature sensor 26, and the case 4 are made of stainless steel, brass, and aluminum alloy, respectively, and these materials each show different linear expansion and contraction properties depending on the ambient temperatures under which they are exposed. The spring 46, however, is adjusted in advance so as to have the elastic force F that counteracts a force Fl caused by the linear expansion and contraction of the metal pipe 6, the temperature sensor 26 and the case 4 in a direction parallel to the pressing direction of the temperature sensor 26 against the metal pipe 6 when the elastic modulus G has been previously set by the selection of a material for the spring 46 and the distance L between the snap ring 44 and the flange 40 in a structure of the case 4 has been previously set.

Since the flange 40 is spaced apart by the distance L1 from the outer surface 4b of the case 4, the temperature sensor 26 is permitted to move in a direction parallel to the pressing direction of itself when the temperature sensor 26 is being pressed against the metal pipe 6 with the elastic force F. However, when the elastic modulus G has been previously set by the selection of a material for the spring 46, and the distance L in a structure of the case 4 has been previously set, the spring 46 is adjusted in advance so as to press the temperature sensor 26 against the metal pipe 6 with the elastic force F which counteracts a frictional force F2 of the O-ring 34 acting on the through-hole 24 in a direction parallel to the pressing direction of the temperature sensor 26 against the metal pipe 6, because the airtightness of the passage 18 is maintained as the O-ring 34 fitted to the temperature sensor 26 comes into intimate contact with the through-hole 24.

The passage 18 is under an internal pressure P of the heating medium including a LLC. Thus, the spring 46 is adjusted in advance so as to press the temperature sensor 26 against the metal pipe 6 with the elastic force F which counteracts the internal pressure P acting on the passage 18 in a direction parallel to the pressing direction of the temperature sensor 26 against the metal pipe 6 when the elastic modulus G has been previously set by the selection of a material for the spring 46, and the distance L in a structure of the case 4 has been previously set.

The temperature sensor 26 pressed against the metal pipe 6 with such an elastic force F is electrically connected to an inverter (not shown) through a lead wire 38 pulled out of its outer end 36. The inverter controls energization (energization interrupting means) by turning on and off the carrying of current to the heater 2 in response to the temperature of the LLC and/or the surface temperature of the metal pipe 6 detected with the temperature sensor 26 through the power unit and the energization circuit described above.

When an LLC exists in the passage 18, the temperature of the LLC is controlled within a proper range by the use of the temperature sensor 26 under this energization control. Thus, the temperature of the heater 2 does not abnormally rise.

On the other hand, conventionally, when no or little LLC exists in the passage 18 due to absence of the LLC supply to the cooling water circuit, a leakage of the LLC from the cooling water circuit or other reasons, there is no or little heating medium for transferring heat from the heater 2. If this happens, the heating device 1 can undergo accidental heating of an empty passage, leading to a trouble that the temperature of the heater 2 itself abnormally rises. Even when such accidental heating of an empty passage occurs, the heating device 1 having the temperature sensor 26, which is out of contact with the metal pipe 6 and capable of detecting only the temperature of the LLC in the case of a conventional heating device, can undergo a deterioration in the responsiveness of the temperature sensor 26 due to the heat-insulation effect of the air surrounding the temperature sensor 26, leading to a delay in the detection of such accidental heating. As a result, temperature in the passage 18 can go on to increase, causing an occurrence of smoke or fire in the heating device 1.

In contrast, the present embodiment provides energization control by taking advantage of a difference in heat transfer property between the LLC as a fluid and the air as a gas, that is, the temperature of the LLC becomes dominant when the LLC exists in the passage 18 and the temperature of the heater 2 becomes dominant when no or little LLC exists in the passage 18, as the temperature sensor 26 is pressed into direct contact with the outer circumference 6a of the metal pipe 6, i.e. the heating portion of the heater 2, while the temperature sensor 26 is placed in the passage 18 where the LLC flows.

The present embodiment as described above provides normal energization control without stopping the heating device 1 for protection when an LLC exists in the passage 18 while the present embodiment provides error processing to stop promptly and reliably the heating device 1 for protection by reliably detecting the accidental heating of an empty passage with the temperature sensor 26 maintained constant contact with the metal pipe 6 as the temperature sensor 26 is pressed against the metal pipe 6 with the elastic force F of the spring 46 when no or little LLC exists in the passage 18. Thus, it is possible to provide the heating device 1 that achieves high reliability as it promptly detects accidental heating of an empty passage with high accuracy and prevents reliably an occurrence of smoke or fire while performing normal energization control by the use of the temperature sensor 26.

In particular, as the elastic force F of the spring 46 has been previously set to a load that counteracts the force Fl caused by the linear expansion and contraction of the metal pipe 6, the temperature sensor 26 and the case 4 in a direction parallel to the pressing direction of the temperature sensor 26 against the metal pipe 6, the heating device 1 is capable of maintaining the end face 30 of the temperature measurement end 28 into constant contact with the outer circumference 6a of the metal pipe 6, promptly detecting accidental heating of an empty passage with high accuracy and reliably preventing an occurrence of smoke or fire, even when the metal pipe 6, the temperature sensor 26 and the case 4 are made of different materials, and the heating device 1 is used under severe ambient temperatures as well as under the influence of linear expansion and contraction.

In addition, as the elastic force F of the spring 46 has been previously set to a load that counteracts the frictional force F2 of the O-ring 34 acting on the through-hole 24 and the internal pressure P acting on the passage 18, the temperature sensor 26 is permitted to move with the elastic force F so as to reliably bring the end face 30 of the temperature measurement end 28 into contact with the outer circumference 6a of the metal pipe 6 without being inhibited by the frictional force F2 and the internal pressure P. The present invention is not limited to the embodiment of the heating device 1 described above, but various modifications may be made.

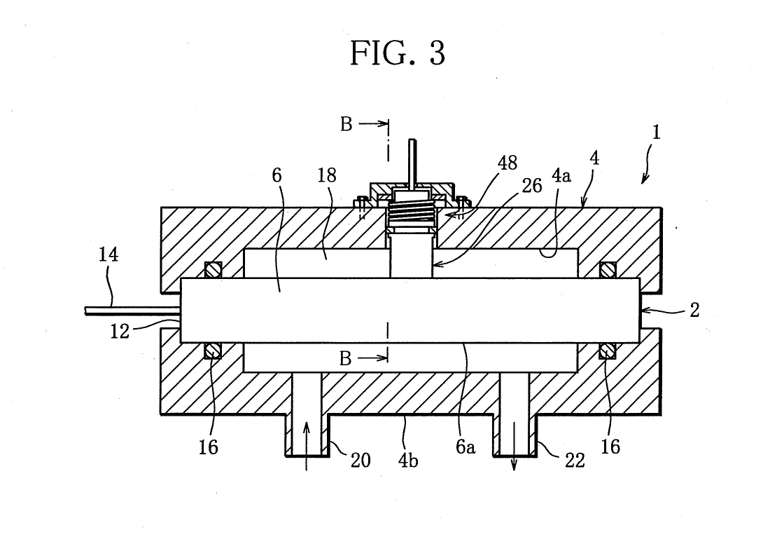

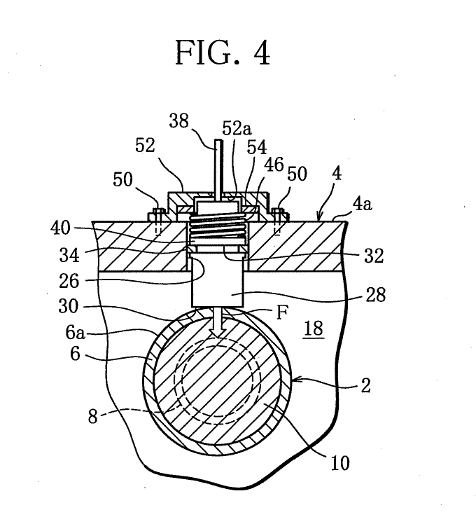

For example, the pressing mechanism 39 for the temperature sensor 26 is not limited to the above-mentioned embodiment, but a pressing mechanism 48 shown in FIGS. 3 and 4 may be used.

Specifically, the flange 40 of the temperature sensor 26 may be made smaller in diameter than the through-hole 24, and placed at the through-hole 24. In addition, a lid member 52 which is fastened to the outer surface 4b of the case 4 with screws 50 may be provided instead of the fixing part 42 and the snap ring 44. Then, the spring 46 may be locked between the flange 40 and the lid member 52. In this case, the more simplified pressing mechanism 48 can be provided because a structural constraint, i.e. the distance L2 needs to be secured in the pressing mechanism 39 for the temperature sensor 26, is eliminated. As a result, the productivity of the heating device 1 can be increased.

As shown in FIGS. 3 and 4, a circular heat-insulation member 54 may be provided between the lid member and the spring 46 so that the spring 46 comes into contact with a back side 52a of the lid member 52 via the heat-insulation member 54. In this case, heat inside the passage 18 dissipated through the lid member 52 via the spring 46 contacting the temperature sensor 26 can be controlled, leading to improved thermal efficiency in the heating device 1. This configuration including the heat-insulation member 54 can be also applied to the pressing mechanism 39 shown in FIGS. 1 and 2.

In the embodiment and the modifications described above, the pressing mechanisms 39, 48 includes the spring 46 as an elastic member for generating the elastic force F. The elastic member is, however, not limited to this example.

Specifically, a coned disc spring or an elastic body such as rubber may be used as long as it is capable of generating the elastic force F.

In the embodiment and the modifications described above, the metal pipe 6, the temperature sensor 26, and the case 4 are made of stainless steel, brass, and aluminum alloy, respectively, but the materials are not limited to these examples. Some of these members may be made of an identical material. Even in such cases, as an elastic member with its elastic force F predetermined is used, the temperature sensor 26 is permitted to move with the elastic force F so as to reliably bring the end face 30 of the temperature measurement end 28 into contact with the outer circumference 6a of the metal pipe 6 without being inhibited by the force Fl caused by linear expansion and contraction, the frictional force F2 and the internal pressure P.

When the set elastic force F is enough to absorb the dimensional and election tolerances of the metal pipe 6, the temperature sensor 26, the pressing mechanism 39 or 48 along with the case 4, and broadly the components of the heating device 1, the end face 30 of the temperature measurement end 28 is allowed to reliably make contact with the outer circumference 6a of the metal pipe 6 without such tolerances being precisely controlled.

Although the temperature sensor 26 acts as a temperature detection means and the inverter for controlling energization acts as an energization interrupting means in the embodiment described above, a thermal fuse or the like incorporating both the temperature detection means and the energization interrupting means may be pressed into contact with the metal pipe 6.

The heating device 1 according to the present invention is not limited to use in a car air conditioning apparatus of an hybrid car or an electric vehicle, but can be used as a heat source for other purposes.

### EXPLANATION OF REFERENCE SIGNS

1 heating device

2 heater

4 case (housing)

6 metal pipe (heating portion)

18 passage

26 temperature sensor (temperature detection means)

34 O-ring (seal member)

46 spring (elastic member)

54 heat-insulation member

1. A heating device comprising:
a heater having a heating portion which generates heat by energization;
a housing which contains the heating portion and forms a passage for a heating medium between the housing and the heating portion;
a temperature detection means for detecting the temperature of the heating medium in the passage; and
an energization interrupting means for interrupting the carrying of current to the heater depending on the temperature of the heating medium detected by the temperature detection means,
wherein an elastic member presses the temperature detection means into contact with the heating portion.

2. The heating device according to claim 1, wherein the elastic member has an elastic force capable of pressing the temperature detection means upon the heating portion against respective forces of the heating portion, the temperature detection means and the housing in linear expansion and linear contraction acting in a direction parallel to a pressing direction of the temperature detection means toward the heating portion.

3. The heating device according to claim 1,
wherein the temperature detection means is connected to the housing via a seal member, and
wherein the elastic member has an elastic force capable of pressing the temperature detection means upon the heating portion against the frictional force of the seal member, the frictional force acting in a direction parallel to the pressing direction of the temperature detection means toward the heating portion.

4. The heating device according to claim 1, wherein the elastic member has an elastic force capable of pressing the temperature detection means upon the heating portion against an internal pressure acting on the passage in a direction parallel to the pressing direction of the temperature detection means toward the heating portion.

5. The heating device according to claim 1, wherein the housing comes into contact with the elastic member via a heat-insulation member.
